(19) United States
(12) Patent Application Publication
(10) Pub. No.: US 2025/0110794 A1
(43) Pub. Date: Apr. 3, 2025

(54) RESOURCE ALLOCATION MECHANISM FOR SCAN APPLICATION PROGRAMMING INTERFACE (API)

(71) Applicant: Samsung Electronics Co., Ltd., Suwon-si, Gyeonggi-do (KR)

(72) Inventors: Amin FALLAHI, San Jose, CA (US); Praveen KRISHNAMOORTHY, Fremont, CA (US); Yangwook KANG, San Jose, CA (US); Changho CHOI, San Jose, CA (US)

(21) Appl. No.: 18/408,561

(22) Filed: Jan. 9, 2024

Related U.S. Application Data
(60) Provisional application No. 63/541,288, filed on Sep. 28, 2023.

(51) Int. Cl. G06F 9/50; G06F 9/48; G06F 16/2455

(52) U.S. Cl. CPC G06F 9/5038; G06F 9/4881; G06F 16/24552

(57) ABSTRACT

An apparatus is disclosed. The apparatus may include a storage device, which may store a database including a table. The apparatus may also include an accelerator connected to the storage device. The accelerator may include a kernel. A scan, associated with a query, may access data from the table in the database stored on the storage device. A scan priority calculator may calculate a priority of the scan. A kernel assignment unit may assign the kernel to the scan based at least in part on the priority of the scan.

### RELATED APPLICATION DATA

This application claims the benefit of U.S. Provisional Patent Application Ser. No. 63/541,288, filed Sep. 28, 2023, which is incorporated by reference herein for all purposes.

### FIELD

The disclosure relates generally to accelerators, and more particularly to improved allocation of resources in an accelerator.

### BACKGROUND

Database queries may involve scans of multiple tables. When queries are processed in parallel, the number of scans may be further increased. While scans may be performed using software solutions provided by a database management system, the use of hardware resources may be more efficient.

A need remains to improve the allocation of accelerator resources in handling scans of tables.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 shows a machine including an accelerator to assign kernels to scans of table queries in a database management system, according to embodiments of the disclosure.

FIG. 2 shows details of the machine of FIG. 1, according to embodiments of the disclosure.

FIG. 3A shows a first example arrangement of the accelerator of FIG. 1 that may be associated with the storage device of FIG. 1, according to embodiments of the disclosure.

FIG. 3B shows a second example arrangement of the accelerator of FIG. 1 that may be associated with the storage device of FIG. 1, according to embodiments of the disclosure.

FIG. 3C shows a third example arrangement of the accelerator of FIG. 1 that may be associated with the storage device of FIG. 1, according to embodiments of the disclosure.

FIG. 3D shows a fourth example arrangement of the accelerator of FIG. 1 that may be associated with the storage device of FIG. 1, according to embodiments of the disclosure.

FIG. 4 shows details of the accelerator of FIG. 1, according to embodiments of the disclosure.

FIG. 5 shows a query with multiple scans, according to embodiments of the disclosure.

FIG. 6 shows the scan priority calculator of FIG. 4 determining a priority for the scan of FIG. 5, according to embodiments of the disclosure.

FIG. 7 shows the kernels of FIG. 4 being assigned to the scans of FIG. 5 according to the scan priorities of FIG. 6, according to embodiments of the disclosure.

FIG. 8 shows the kernel release unit of FIG. 4 determining when to release the kernels of FIG. 4, according to embodiments of the disclosure.

FIG. 9 shows a flowchart of an example procedure for the accelerator of FIG. 1 to assign the kernels of FIG. 4 to the scans of FIG. 5, according to embodiments of the disclosure.

FIG. 10 shows a flowchart of an example procedure for the accelerator of FIG. 1 to determine the scans of FIG. 5, according to embodiments of the disclosure.

FIG. 11 shows a flowchart of an example procedure for the accelerator of FIG. 1 to determine the scan priorities of FIG. 6 for the scans of FIG. 5, according to embodiments of the disclosure.

FIG. 12 shows a flowchart of an example procedure for the accelerator of FIG. 1 to use the kernels of FIG. 4 to execute the scans of FIG. 5 and to release the kernels of FIG. 4, according to embodiments of the disclosure.

FIG. 13 shows a flowchart of an example procedure for the accelerator of FIG. 1 to flush cache data, according to embodiments of the disclosure.

FIG. 14 shows a flowchart of an example procedure for the accelerator of FIG. 1 to determine whether a kernel of FIG. 4 that has been assigned to a scan of FIG. 5 but has not been allocated to the scan of FIG. 5 may be released, according to embodiments of the disclosure.

### SUMMARY

An accelerator may determine priorities for various scans in pending queries of a database. The accelerator may then assign accelerator kernels to the various scans in proportion to the priorities of the various scans.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Database management systems may receive queries submitted by any number of clients. Each client may submit any number of queries, each of which may involve scans of any number of tables. Because the database management system might not know when any client will submit queries, the database management system might end up processing any number of queries in parallel.

The scan of each table may be performed in software, or in hardware if hardware resources are available. For example, an accelerator may include one or more kernels with implemented scan algorithms that may be used to scan a table.

Embodiments of the disclosure provide for a more efficient allocation of accelerator resources by determining a priority value for each kernel in the accelerator, then assigning available kernels to the scans in proportion to their priority. The priority for each scan may consider cache statistics as well as the size of the information to be scanned: cache statistics may be queried from the database management system. Higher priority scans may be assigned a larger number of kernels, with relatively low priority scans falling back on software scan implementations.

Embodiments of the disclosure may also recognize that just because kernels are assigned to scans does not mean that the database management system may use the kernels to perform the scan. For example, the database management system might implement a cost function, which might determine that the software scan may be faster: for example, based on how the data from the table is to be used. Embodiments of the disclosure may recognize that a kernel was not actually allocated to the scan, and may release that kernel back to the pool of available kernels for use by other scans.

Embodiments of the disclosure may also recognize that scans performed by the database management system software may include data in caches belonging to either the database management system or the operating system. To ensure that all current data is available for scans being performed by kernels, the caches may be flushed to disk before the kernels perform the scans.

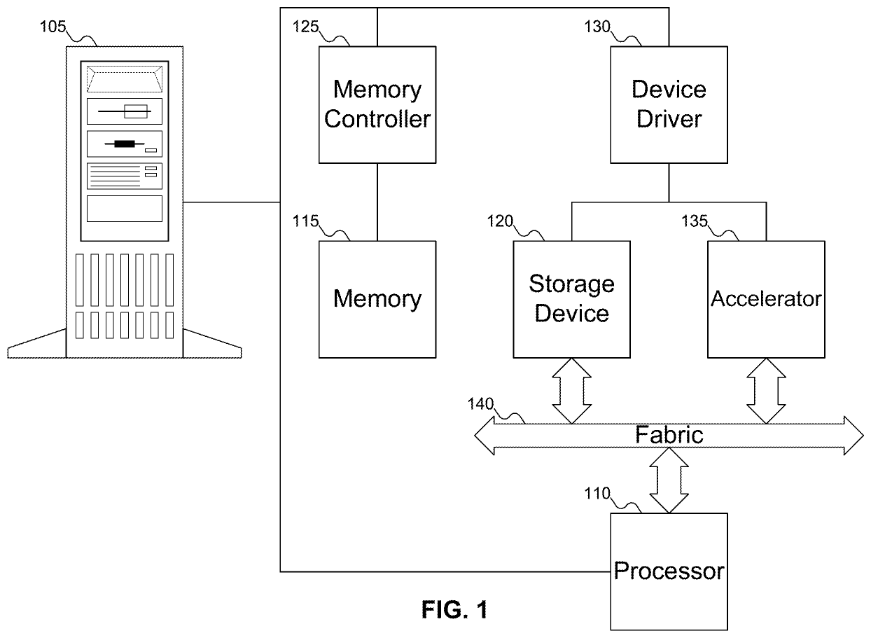

FIG. 1 shows a machine including an accelerator to assign kernels to scans of table queries in a database management system, according to embodiments of the disclosure. In FIG. 1, machine 105, which may also be termed a host or a system, may include processor 110, memory 115, and storage device 120. Machine 105 may also be considered a database management system, or may be considered to host (that is, execute) a database management system software.

Processor 110 may be any variety of processor. (Processor 110, along with the other components discussed below, are shown outside the machine for case of illustration: embodiments of the disclosure may include these components within the machine.) While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage device 120. Storage device 120 may be accessed using device driver 130.

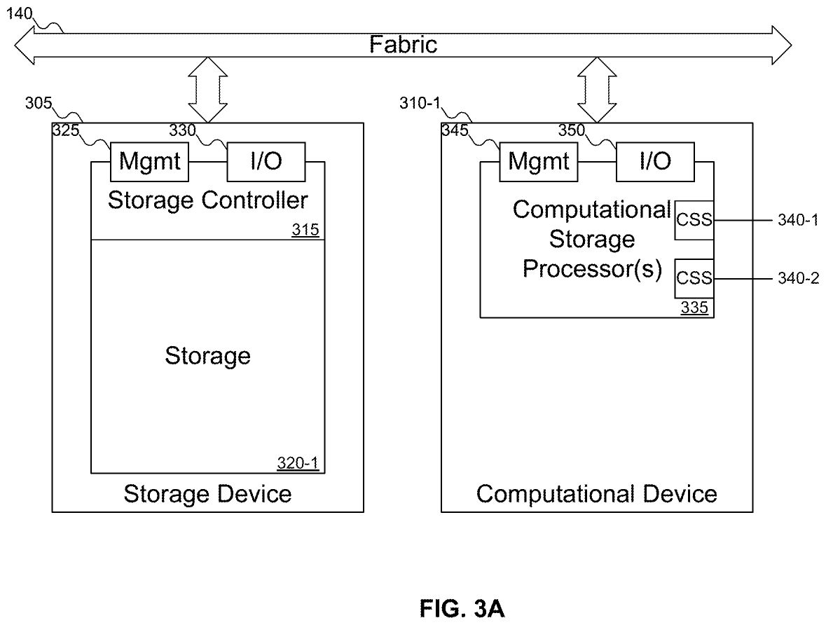

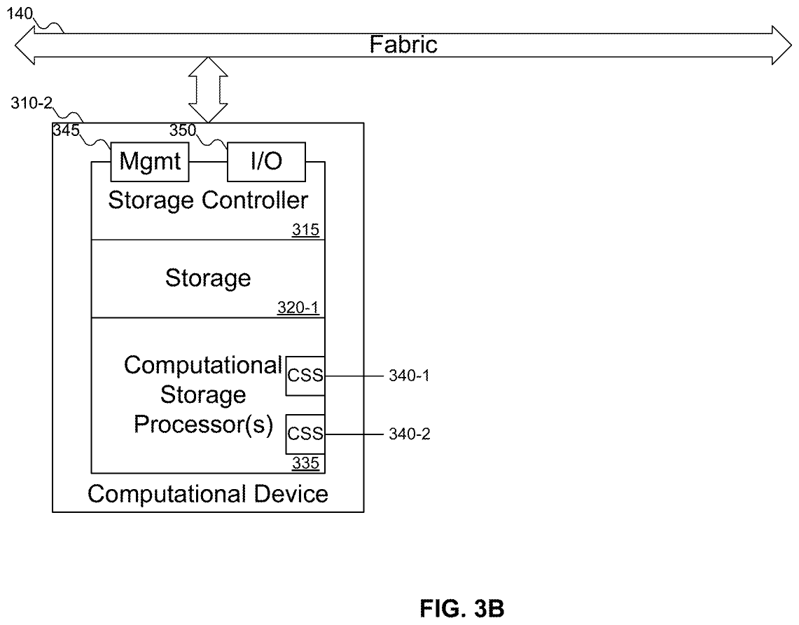

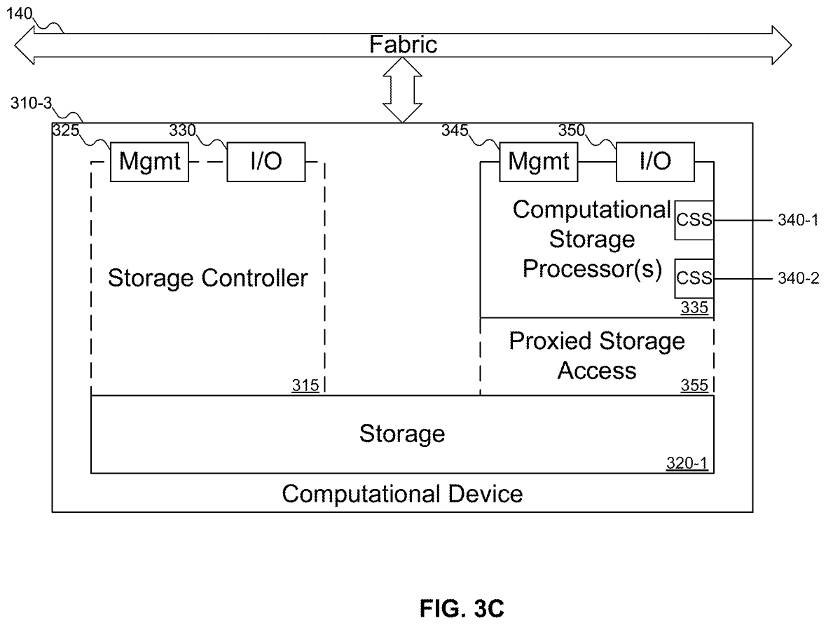

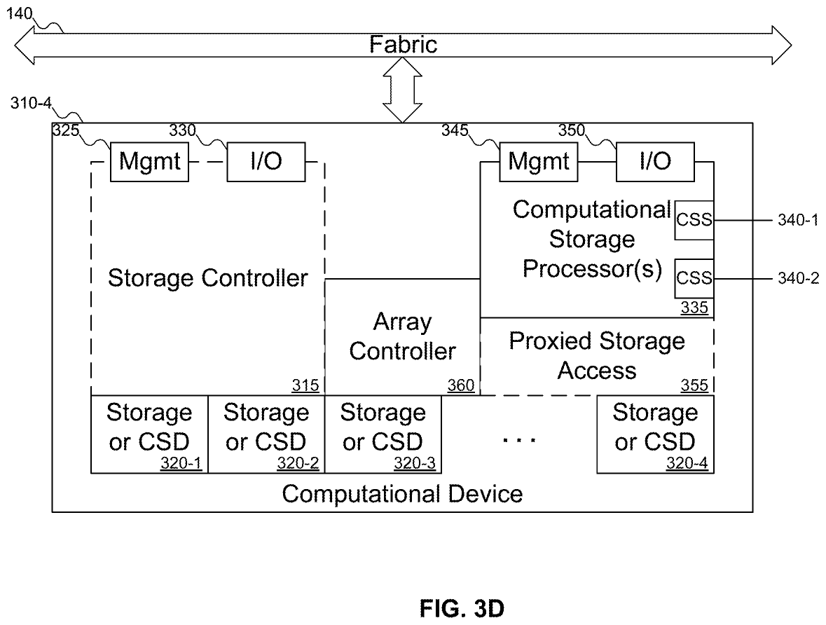

Storage device 120 may be associated with accelerator 135, which may also be referred to as a computational storage unit, computational storage device, or computational device. As discussed with reference to FIGS. 3A-3D below, storage device 120 and accelerator 135 may be designed and manufactured as a single integrated unit, or accelerator 135 may be separate from storage device 120. The phrase “associated with” is intended to cover both a single integrated unit including both a storage device and an accelerator and a storage device that is paired with an accelerator but that are not manufactured as a single integrated unit. In other words, a storage device and an accelerator may be said to be “paired” when they are physically separate devices but are connected in a manner that enables them to communicate with each other. Further, in the remainder of this document, any reference to storage device 120 and/or accelerator 135 may be understood to refer to the devices either as physically separate but paired (and therefore may include the other device) or to both devices integrated into a single component as a computational storage unit.

In addition, the connection between the storage device and the paired accelerator might enable the two devices to communicate, but might not enable one (or both) devices to work with a different partner: that is, the storage device might not be able to communicate with another accelerator, and/or the accelerator might not be able to communicate with another storage device. For example, the storage device and the paired accelerator might be connected serially (in either order) to the fabric, enabling the accelerator to access information from the storage device in a manner another accelerator might not be able to achieve.

While FIG. 1 uses the generic term “storage device”, embodiments of the disclosure may include any storage device formats that may be associated with computational storage, examples of which may include hard disk drives and Solid State Drives (SSDs). Any reference to a specific type of storage device, such as an “SSD”, below should be understood to include such other embodiments of the disclosure.

Processor 105, storage device 120, and accelerator 135 are shown as connecting to fabric 140. Fabric 140 is intended to represent any fabric along which information may be passed. Fabric 140 may include fabrics that may be internal to machine 105, and which may use interfaces such as Peripheral Component Interconnect Express (PCIe), Serial AT Attachment (SATA), Small Computer Systems Interface (SCSI), among others. Fabric 140 may also include fabrics that may be external to machine 105, and which may use interfaces such as Ethernet, Infiniband, or Fibre Channel, among others. In addition, fabric 140 may support one or more protocols, such as Non-Volatile Memory Express (NVMe), NVMe over Fabrics (NVMe-oF), or Simple Service Discovery Protocol (SSDP), among others. Thus, fabric 140 may be thought of as encompassing both internal and external networking connections, over which commands may be sent, either directly or indirectly, to storage device 120 (and more particularly, accelerator 135 associated with storage device 120). In embodiments of the disclosure where fabric 140 supports external networking connections, storage device 120 and/or accelerator 135 might be located external to machine 105.

FIG. 1 shows processor 105, storage device 120, and accelerator 135 as being connected to fabric 140 because processor 105, storage device 120, and accelerator 135 may communicate via fabric 140. In some embodiments of the disclosure, storage device 120 and/or accelerator 135 may include a connection to fabric 120 that may include the ability to communicate with a remote machine and/or a network: for example, a network-capable Solid State Drive (SSD). But in other embodiments of the disclosure, while machine 105 may include a connection to another machine and/or a network (which connection may be considered part of fabric 140), storage device 120 and/or accelerator 135 might not be connected to another machine and/or network. In such embodiments of the disclosure, storage device 120 and/or accelerator 135 may still be reachable from a remote machine, but such commands may pass through processor 110, among other possibilities, to reach storage device 120 and/or accelerator 135.

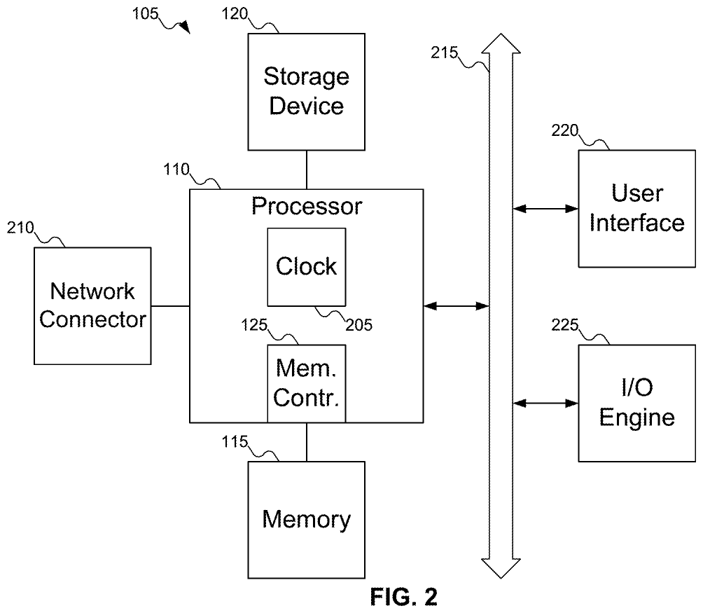

FIG. 2 shows details of machine 105 of FIG. 1, according to embodiments of the disclosure. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components.

FIGS. 3A-3D show various arrangements of accelerator 135 of FIG. 1 that may be associated with storage device 120 of FIG. 1, according to embodiments of the disclosure. In FIG. 3A, storage device 305 (which may be storage device 120 of FIG. 1) and computational device 310-1 (which may be accelerator 135 of FIG. 1, and which may also be referred to as a computational storage unit, a computational storage device, or a device) are shown. Storage device 305 may include controller 315 and storage 320-1. Storage device 305 may be reachable using any desired form of access. For example, in FIG. 3A, storage device 305 may be accessed across fabric 140 using a submission queue and a completion queue, which may form a queue pair. In FIG. 3A, storage device 305 is shown as including two queue pairs: management queue pair 325 may be used for management of storage device 305, and I/O queue pair 330 may be used to control I/O of storage device 305. (Management queue pair 325 and I/O queue pair 330 may be referred to more generally as queue pairs 325 and 330, without reference to their specific usage.) Embodiments of the disclosure may include any number (one or more) of queue pairs 325 and 330 (or other forms of access), and access may be shared: for example, a single queue pair may be used both for management and I/O control of storage device 305 (that is, queue pairs 325 and 330 may be combined in one queue pair).

Computational device 310-1 may be paired with or associated with storage device 305. Computational device 310-1 may include any number (one or more) processors 335, which may also be referred to as computational storage processors, computational engines, or engines, Processors 335 may offer one or more services 340-1 and 340-2, which may be referred to collectively as services 340, and which may be also be referred to as computational storage services (CSSs). To be clearer, each processor 335 may offer any number (one or more) services 340 (although embodiments of the disclosure may include computational device 310-1 including exactly two services 340-1 and 340-2 as shown in FIG. 3A). Services 340 may be functions that are built into processors 335, functions downloaded from processor 110 of FIG. 1 (that is, custom functions that processor 110 of FIG. 1 wants supported by processors 335), or both. Computational device 310-1 may be reachable across management queue pair 345 and/or I/O queue pair 350, which may be used for management of computational device 310-1 and/or to control I/O of computational device 310-1 respectively, similar to queue pairs 325 and 330 for storage device 305. (Management queue pair 345 and I/O queue pair 350 may be referred to more generally as queue pairs 345 and 350, without reference to their specific usage.) Like queue pairs 325 and 330, other forms of access may be used other than queue pairs 345 and 350, and a single queue pair may be used both for management and I/O control of computational device 310-1 (that is, queue pairs 345 and 350 may be combined in one queue pair).

Processors 335 may be thought of as near-storage processing: that is, processing that is closer to storage device 305 than processor 110 of FIG. 1. Because processors 335 are closer to storage device 305, processors 335 may be able to execute commands on data stored in storage device 305 more quickly than for processor 110 of FIG. 1 to execute such commands. While not shown in FIG. 3A, processors 335 may have associated memory which may be used for local execution of commands on data stored in storage device 305.

While FIG. 3A shows storage device 305 and computational device 310-1 as being separately reachable across fabric 140, embodiments of the disclosure may also include storage device 305 and computational device 310-1 being serially connected. That is, commands directed to storage device 305 and computational device 310-1 might both be received at the same physical connection to fabric 140 and may pass through one device to reach the other. For example, if computational device 310-1 is located between storage device 305 and fabric 140, computational device 310-1 may receive commands directed to both computational device 310-1 and storage device 305: computational device 310-1 may process commands directed to computational device 310-1, and may pass commands directed to storage device 305 to storage device 305.

Services 340 may offer a number of different functions that may be executed on data stored in storage device 305. For example, services 340 may offer pre-defined functions, such as encryption, decryption, compression, and/or decompression of data, erasure coding, and/or applying regular expressions. Or, services 340 may offer more general functions, such as data searching and/or SQL functions. Services 340 may also support running application-specific code. That is, the application using services 340 may provide custom code to be executed using data on storage device 305. In some embodiments of the disclosure, services 340 may be stored in “program slots”: that is, particular addresses ranges within processors 335. Services 340 may also any combination of such functions. Table 1 lists some examples of services that may be offered by processors 335.

TABLE 1
Service Types

Compression
Encryption
Database filter
Erasure coding
RAID
Hash/CRC
RegEx (pattern matching)
Scatter Gather
Pipeline
Video compression
Data Deduplication
Operating System Image Loader
Container Image Loader
Berkeley packet filter (BPF) loader
FPGA Bitstream loader
Large Data Set

Processors 335 (and, indeed, computational device 310-1) may be implemented in any desired manner. Example implementations may include a local processor, such as Central Processing Unit (CPU), a Graphics Processing Unit (GPU), a General Purpose GPU (GPGPU), a Data Processing Unit (DPU), and a Tensor Processing Unit (TPU), among other possibilities. Processors 335 may also be implemented using Field Programmable Gate Array (FPGA), an Application-Specific Integrated Circuit (ASIC), or a System-on-a-Chip, among other possibilities. If computational device 310-1 includes more than one processor 335, each processor 335 may be implemented as described above. For example, computational device 310-1 might have one each of CPU, TPU, and FPGA, or computational device 310-1 might have two FPGAs, or computational device 310-1 might have two CPUs and one ASIC, etc.

Depending on the desired interpretation, either computational device 310-1 or processor(s) 335 may be thought of as a computational storage unit.

Whereas FIG. 3A shows storage device 305 and computational device 310-1 as separate devices, in FIG. 3B they may be combined into a single computational device. Thus, computational device 310-2 may include controller 315, storage 320-1, and processor(s) 335 offering services 340-1 and 340-2. As with storage device 305 and computational device 310-1 of FIG. 3A, management and I/O commands may be received via queue pairs 345 and/or 350. Even though computational device 310-2 is shown as including both storage and processor(s) 335, FIG. 3B may still be thought of as including a storage device that is associated with a computational storage unit.

In yet another variation shown in FIG. 3C, computational device 310-3 is shown. Computational device 310-3 may include controller 315 and storage 320-1, as well as processor(s) 335 offering services 340-1 and 340-2. But even though computational device 310-3 may be thought of as a single component including controller 315, storage 320-1, and processor(s) 335 (and also being thought of as a storage device associated with a computational storage unit), unlike the implementation shown in FIG. 3B controller 315 and processor(s) 335 may each include their own queue pairs 325 and/or 330 and 345 and/or 350 (again, which may be used for management and/or I/O). By including queue pairs 325 and/or 330, controller 315 may offer transparent access to storage 320-1 (rather than requiring all communication to proceed through processor(s) 335), whereas queue pairs 345 and/or 350 may be used to access processor(s) 335.

In addition, processor(s) may have proxied storage access 355 to use to access storage 320-1. Instead of routing access requests through controller 315, processor(s) 335 may be able to directly access the data from storage 320-1 using proxied storage access 355.

In FIG. 3C, both controller 315 and proxied storage access 355 are shown with dashed lines to represent that they are optional elements, and may be omitted depending on the implementation.

Finally, FIG. 3D shows yet another implementation. In FIG. 3D, computational device 310-4 is shown, which may include an array, which may include one or more storage 320-1 through 320-4. While FIG. 3D shows four storage elements, embodiments of the disclosure may include any number (one or more) of storage elements. In addition, the individual storage elements may be other storage devices, such as those shown in FIGS. 3A-3D.

Because computational device 310-4 may include more than one storage element 320-1 through 320-4, computational device 310-4 may include array controller 360. Array controller 360 may manage how data is stored on and retrieved from storage elements 320-1 through 320-4. For example, if storage elements 320-1 through 320-4 are implemented as some level of a Redundant Array of Independent Disks (RAID), array controller 360 may be a RAID controller. If storage elements 320-1 through 320-4 are implemented using some form of Erasure Coding, then array controller 360 may be an Erasure Coding controller.

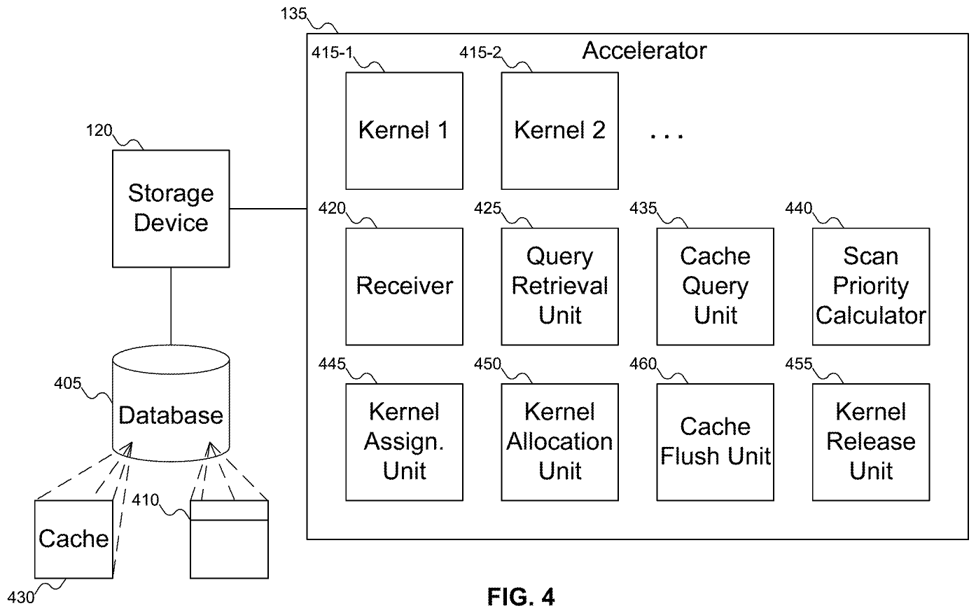

FIG. 4 shows details of accelerator 135 of FIG. 1, according to embodiments of the disclosure. In FIG. 4, accelerator 135 may communicate with storage device 120 (for example, across fabric 140 of FIG. 4) to access database 405, which may include tables, such as table 410. While FIG. 4 shows storage device 120 as storing one database 405, which is shown as including one table 410, embodiments of the disclosure may support any number (one or more) of databases 405 stored on storage device 120, each or which may include any number (one or more) of tables 410. Database 405 may receive queries from various clients, to access information from tables 410.

Accelerator 135 may include various kernels, such as kernels 415-1 and 415-2 (which may be referred to collectively as kernels 415). Kernels 415 may be assigned to execute various scans of tables 410 in database 405. Each kernel 415 may be implemented in any desired manner. For example, each kernel 415 may include a Field Programmable Gate Array (FPGA), an Application-Specific Integrated Circuit (ASIC), a System-on-a-Chip, a Central Processing Unit (CPU), a Graphics Processing Unit (GPU), a General Purpose GPU (GPGPU), a Data Processing Unit (DPU), or a Tensor Processing Unit (TPU), among other possibilities. Each kernel 415 may also be implemented differently from other kernels 415. For example, kernel 415-1 might be implemented as an FPGA, whereas kernel 415-2 might be implemented as a CPU.

Each kernel 415 may be designed to implement a particular scan function. A scan function may access data from table 410 using any desired algorithm. For example, one scan function might access data by reading one row of data at a time, whereas another scan function might access data by reading one column of data at a time. Different kernels 415 may implement the same or different scan functions, as desired.

While FIG. 4 shows only two kernels 415, embodiments of the disclosure may include any number (one or more) of kernels 415. In addition, while FIG. 4 shows kernels 415 as part of accelerator 135, in some embodiments of the disclosure accelerator 135 may provide for allocation of kernels 415 that are external to accelerator 135. For example, storage device 120 might be coupled to two accelerators 135, one of which may include kernels 415 and the other of which may be used to assign kernels 415 to execute scans of tables 410 in database 405.

To assign kernels 415 to scans, accelerator 135 may need to know what queries are currently pending. In some embodiments of the disclosure, receiver 420 may receive a query from a client. This query may be sent to accelerator 135 rather than, or in addition to, the query being sent to database 405.

In other embodiments of the disclosure, accelerator 135 may request any pending queries from database 405. Accelerator 135 may include query retrieval unit 425, which may interrogate database 405 for any currently pending queries. In some embodiments of the disclosure, query retrieval unit 425 may directly retrieve any pending queries from somewhere in database 405; in other embodiments of the disclosure, query retrieval unit 425 may send an inquiry to database 405 to learn what queries are currently pending, and database 405 may respond with any currently pending queries, which may be received by accelerator 135 using receiver 420. For example, query retrieval unit 425 may access the cumulative statistics system for database 405, which may include information about what queries are currently pending.

Note that the above discussion focuses on “currently pending queries”. Once database 405 (or kernels 415) has/have begun to process a query, the query is no longer “pending”, but “in process”. Once processing of a query has begun, processing may be expected to continue using the selected approach. But in some embodiments of the disclosure, queries that are “in process” may be assigned or reassigned to different resources. For example, a query being processed in software might be reassigned to a hardware kernel that became available after finishing processing of a previous query.

Regardless of how accelerator 135 learns of any pending queries, accelerator 135 may next identify any scans applicable to (for example, to be performed as part of processing) the queries. In general, a “scan” may be understood to involve reading or otherwise processing data in one or more tables. Accelerator 135 may include a parser (not shown in FIG. 4) to parse the queries to identify the scans applicable to the queries. Note that the queries may be structured according to a particular grammar, making such parsing possible. But since database 405 may include such a parser (to parse the queries for processing by database 405), accelerator 135 may also ask database 405 to parse the queries to identify the scans applicable to the queries.

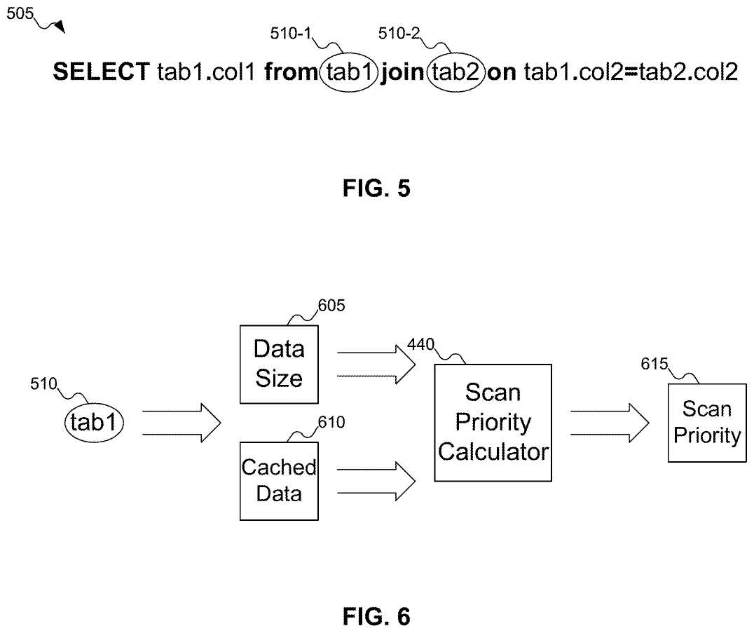

FIG. 5 shows a query with multiple scans, according to embodiments of the disclosure. In FIG. 5, query 505 is shown. Query 505 requests a particular column of data from a particular table 410 of FIG. 4 be retrieved, based on where two columns in the table and another table have the same values. Query 505 may therefore involve two scans: one scan of each table. These scans are shows as scans 510-1 and 510-2 (which may be referred to collectively as scans 510). Embodiments of the disclosure may include any number (zero or more) of scans 510 in query 505, and any number (zero or more) of queries 505 may be handled by the database management system at any time. And while FIG. 5 shows scans 510 has being related to individual tables, as noted above, embodiments of the disclosure may include scans that may involve multiple tables.

Returning to FIG. 4, once scans 510 of FIG. 5 of queries 505 of FIG. 5 have been identified—and once the tables to be accessed to satisfy such scans 510 of FIG. 5 have been identified—accelerator 135 may begin to determine the priority for each scan 510 of FIG. 5. There are various criteria that may be used to determine the priority for scans 510 of FIG. 5. For example, if a scan 510 of FIG. 5 is already being processed by kernel 415-1 for some query 505 of FIG. 5, then kernel 415-1 may be assigned to process that same scan 510 of FIG. 5 for another query 505 of FIG. 5. Note that if kernel 415 is already executing scan 510 of FIG. 5 for some query 505 of FIG. 5, then there is no need to calculate a priority for that same scan 510 of FIG. 5 for another query 505 of FIG. 5: the same kernel may be used for scan 510 of FIG. 5 in question, without using another kernel 415 that might otherwise be used.

Another criteria that may be used to determine a priority for scan 510 of FIG. 5 may be how much information from the table may already be cached. As noted above, database 405 may include a software implementation to execute scan 510 of FIG. 5. To support such execution of scan 510 of FIG. 5, database 405 may include a cache, such as cache 430 (which might be stored, for example, in memory 115 of FIG. 1). In addition, because the database management system may be executing on machine 105 of FIG. 1, an operating system running on processor 110 of FIG. 1 may include its own cache of data. These caches may be used to expedite access to data that is (or is expected to be) frequently accessed, as such caches may be stored in memory systems that may be faster to access than storage device 120. In the remainder of this document, any reference to cache 430 may be understood to refer to either or both of cache 430 and a cache managed by the operating system running on processor 110 of FIG. 1.

But accelerator 135 might not have access to cache 430. For example, a benefit of accelerator 135 is that it is “near” to storage device 120, and therefore may access data from storage device 120 faster than processor 110 of FIG. 1 (accelerator 135 might access storage device 120 via a bus that offers higher bandwidth than the busses that may connect processor 110 of FIG. 1 to storage device 120). But for data that is cached in memory 115 of FIG. 1 or processor 110 of FIG. 1, this higher-speed bus might not be beneficial: to access the data from such caches might require using the same busses that processor 110 of FIG. 1 might use to access storage device 120. If enough data is currently cached in cache 430, then the advantage of near-data processing by kernel 415 might be negated, and it might be more efficient to let database 405 handle scan 510 of FIG. 5 in software, and the priority for scan 510 of FIG. 5 might be set to zero (or some other low priority value).

To determine whether enough data is currently cached in cache 430, accelerator 135 might want to know how much data there is in table 410, and how much of the data in table 410 is currently cached in cache 430. Database 405 may have such information. For example, database 405 may know how large table 410 is, as well as how much data is currently cached in cache 430. Thus, cache query unit 435 may query 505 of FIG. 5 database 405 for such information.

Once accelerator 135 receives information about the size of table 410 and the amount of data from table 410 that is currently cached in cache 430, accelerator 135 may determine if the benefit of kernel 415 executing scan 510 of FIG. 5 is sufficient to justify prioritizing the use of kernel 415 to execute scan 510 of FIG. 5. For example, as discussed above, accelerator 135 might not have access to cache 430 (or might not have sufficiently fast access to cache 430). Thus, if any data for table 410 is currently cached in cache 430, then it might be necessary to flush that data from cache 430 back to storage device 120, so that kernel 415 may have access to the most current information from table 410 (and to prevent clients from updating data for table 410 in cache 430, which might not be written to storage device 120 in time for kernel 415 to perform scan 510 of FIG. 5 on the updated data in table 410). If more than 50% (or some other threshold) of table 410 is already in cache 430, it might be more efficient to let database 405 perform scan 510 of FIG. 5 of table 410 rather than have kernel 415 execute scan 510 of FIG. 5, and the priority for scan 510 of FIG. 5 might be set to zero (or some other low priority value).

In addition, database 405 might have information about how much data from table 415 in cache 430 is dirty: that is, how much data from table 415 in cache 430 has been updated by clients but not yet written back to storage device 120. If the amount of dirty data from table 415 in cache 430 is greater than some threshold amount of data, again, it might be more efficient to let database 405 perform scan 510 of FIG. 5 of table 410 rather than have kernel 415 execute scan 510 of FIG. 5, and the priority for scan 510 of FIG. 5 might be set to zero (or some other low priority value).

The parameters indicated above—the threshold amount of data from table 410 that is resident in cache 430, or the amount of data from table 410 in cache 430 that is dirty—are tunable parameters. Embodiments of the disclosure may support using any values for such parameters, without limitation. In addition, the form these parameters take may be adjusted as desired. For example, while the threshold amount of data from table 410 cached in cache 430 is described as a percentage, a fixed amount of data (which might be expressed in bytes or some multiple thereof, or in other units such as blocks as stored on storage device 120) may be used instead. Similarly, while the threshold amount of data from table 410 in cache 430 that is dirty is described as some amount of data (which might be expressed in bytes or some multiple thereof, or in other units such as blocks as stored on storage device 120), a percentage of the size of table 410 may be used instead.

Assuming that there is no reason to set the priority of scan 510 of FIG. 5 to zero, scan priority calculator 440 may be used to calculate a priority for scan 510 of FIG. 5. Any desired algorithm may be used to calculate the priority for scan 510 of FIG. 5. For example, the priority may be calculated based on the size of table 410 and the amount of data from table 410 in cache 430. As a particular example, the priority might be calculated as the size of table 410, less the amount of data from table 410 currently cached in cache 430. As an equation, the priority for scan 510 of FIG. 5 may be set equal to total table blocks−(cached dirty data blocks+cached valid data blocks). (Note that the above equation uses blocks rather than bytes, but embodiments of the disclosure may support using bytes or other units of data instead).

In the above description, priority may be given to scans of tables 410 that are relatively larger over scans of tables 410 that are relatively smaller. In addition, the priority of scan 510 of FIG. 5 may be reduced based on the amount of data from table 410 currently cached in cache 430. These factors imply that higher values indicate higher priorities for scans, and lower values indicate lower priorities for scans. But embodiments of the disclosure may also include scan priority calculator 440 calculating priorities with low values indicating relatively high priority, and high values indicating relatively low priority.

FIG. 6 shows scan priority calculator 440 of FIG. 4 determining a priority for scan 510 of FIG. 5, according to embodiments of the disclosure. In FIG. 6, given scan 510 (which involves table 410 of FIG. 4), cache query unit 435 of FIG. 4 may be used to determine data size 605 of table 410 of FIG. 4 and/or cached data size 610 of table 410 of FIG. 4 (which may involve either or both of the amount of dirty data in cache 430 of FIG. 4 for table 410 of FIG. 4 and the amount of clean data in cache 430 of FIG. 4 for table 410 of FIG. 4). Scan priority calculator 440 may then use data size 605 and cached data size 610 to determine priority 615 to be assigned to scan 510.

Returning again to FIG. 4, once priorities 615 of FIG. 6 have been assigned to all scans 510 of FIG. 5 in pending queries, kernel assignment unit 445 may assign kernels 415 to scans 510 of FIG. 5 based on their priority 615 of FIG. 6. Any approach may be used to assign kernels 415 to scans. For example, kernels 415 may be assigned to scans 510 of FIG. 5 in order of priorities 615 of FIG. 6. That is, one or more kernels 415 may be assigned to scan 510 of FIG. 5 with the highest priority 615 of FIG. 6, then one or more kernels 415 may be assigned to scan 510 of FIG. 5 with the next highest priority 615 of FIG. 6, and so on. Or, kernels 415 may be assigned to scans 510 of FIG. 5 according to their priorities 615 of FIG. 6, but also weighted by the relative priority 615 of FIG. 6 of each scan 510 of FIG. 5. That is, the total number of available kernels may be determined, and that number of available kernels may then be multiplied by the ratio of priority 615 of FIG. 6 of an individual scan 510 of FIG. 5 relative to the sum of all scan priorities 615 of FIG. 6. This approach gives higher priority scans 510 of FIG. 5 more kernels 415, but may avoid a scan 510 of FIG. 5 being “starved” of kernels 415 due to it having a relatively low priority 615 of FIG. 6. Put another way, using a weighted priority 615 of FIG. 6 may help to ensure that every scan 510 of FIG. 5 may be assigned a kernel 415, even if scan 510 of FIG. 5 does not have a relatively high priority 615 of FIG. 6. As an equation, if k represents the number of available kernels, s represents the number of scans 510 of FIG. 5, and pᵢ represents priority 615 of FIG. 6 of the i^{th} scan, then the number of kernels to assign to an individual scan 510 of FIG. 5 may be represented as

$${a}_{i} = k \times \frac{{p}_{i}}{{Σ}_{i = 1}^{s} {p}_{i}} .$$

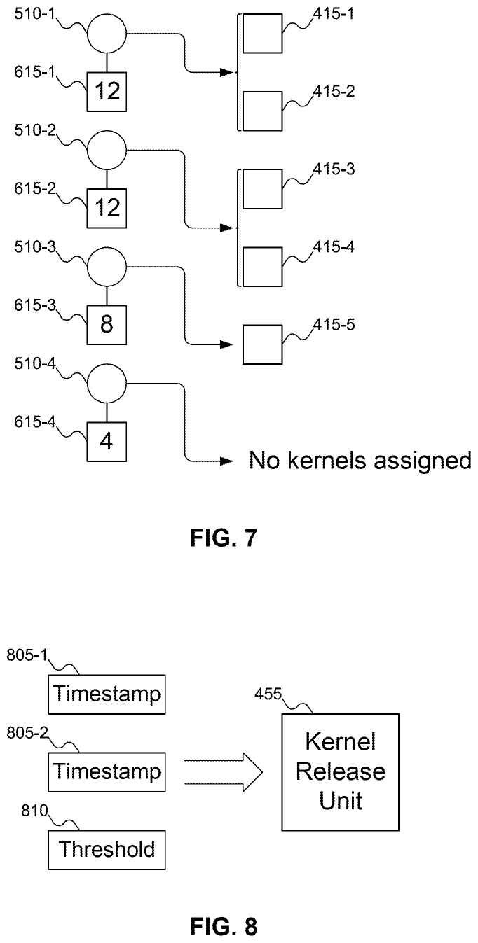

If this equation does not result in an integer number of kernels to assign to as particular scan 510 of FIG. 5, then the result of this calculation may be rounded (up or down) to the nearest integer, or the fractional portion may simply be discarded. FIG. 7 below shows an example of the application of this weighted priority approach.

The above approach might treat all kernels 415 as equal. That is, in determining priorities 615 of FIG. 6, kernel assignment unit 445 might assume that any kernel 415 may execute any scan 510 of FIG. 5. If different kernels 415 implement different scan functions, this assumption might not be true. To address such an assumption, kernel assignment unit 445 might group available kernels 415 based on what scan functions they actually implement, and may treat each group of available kernels 415 separately. Similarly, kernel assignment unit 445 might group scans 510 of FIG. 5 based on which kernels 415 might be able to perform each scan 510 of FIG. 5. In such situations, the same equations described above may be used, except that the number k of available kernels 415 and the number s of scans 510 of FIG. 5 may be reduced to the size of each applicable group (that is, the number of scans 510 of FIG. 5 expected to be performed using similar algorithms and the number of kernels 415 that may execute such algorithms). Of course, in embodiments of the disclosure where kernels 415 may be modified to execute different scan functions (for example, embodiments of the disclosure using processors or FPGAs to implement kernels 415), any kernel 415 might be able to perform any scan function simply by modifying kernel 415 appropriately for the next scan function, in which case such subdivision of kernels 415 and scans 510 of FIG. 5 may be avoided.

In some situations, scan 510 of FIG. 5 might have a sufficiently low priority 615 of FIG. 6 relative to other scans 510 of FIG. 5 that kernel assignment unit 445 might not end up assigning any kernels 415 to scan 510 of FIG. 5. In that situation, a software implementation of a scan algorithm may be used to execute scan 510 of FIG. 5, with kernels 415 not being considered for scan 510 of FIG. 5.

Note that accelerator 135 may be used at any time to determine priorities 615 of FIG. 6 for scans 510 of FIG. 5. In some situations, accelerator 135 may be expected to determine priorities 615 of FIG. 6 for scans 510 of FIG. 5 when kernels 415 are already executing other scans 510 of FIG. 5. For example, query 505 of FIG. 5 might be received from a client after other client queries 505 of FIG. 5 are already being processed. In such situations, accelerator 135 might allocate only among kernels 415 that are currently available: that is, kernels 415 not currently assigned to execute scans 510 of FIG. 5. Thus, if accelerator 135 includes, for example, 10 kernels 415, but six kernels 415 are already executing scans 510 of FIG. 5 or are assigned to scans 510 of FIG. 5 but have not begun executing scans 510 of FIG. 5, then there might only be four kernels 415 available for assignment to scans 510 of FIG. 5 for the newly received query 505 of FIG. 5, and kernel assignment unit 445 may function to assign from among only those four kernels 415 rather than from all 10 kernels 415. In other embodiments of the disclosure, accelerator 135 may determine priorities 615 of FIG. 6 for scans 510 of FIG. 5 even for kernels 415 that are currently executing scans 510 of FIG. 5: kernels 415 already executing scans 510 of FIG. 5 might then be reassigned to new scans 510 of FIG. 5 based on the new scan priorities 615 of FIG. 6.

In some embodiments of the disclosure, kernel assignment unit 445 may choose to assign all available kernels 415 to scans 510 of FIG. 5. This approach may minimize downtime for kernels 415: keeping kernels 415 functioning as much as possible may be an objective. But in other embodiments of the disclosure, kernel assignment unit 445 might choose not to assign a kernel 415 to scan 510 of FIG. 5, even though kernel 415 is available. For example, kernel assignment unit 415 might keep a certain number or percentage of kernels 415 unassigned so that they are available for other scans 510 of FIG. 5 that might be received in the future. This approach might aim for optimizing scan efficiency rather than kernel maximization. Or, kernel assignment unit 445 might wait to assign scans 510 of FIG. 5 for query 505 of FIG. 5 until enough kernels 415 are available for scans 510 of FIG. 5 for query 505 of FIG. 5. This approach might aim to ensure queries are performed in kernels 415 if at all possible, even if query 505 of FIG. 5 might be delayed waiting for kernels 415 to become available (recognizing that processing of query 505 of FIG. 5 using kernels 415 might be faster than using software, even accounting for a delay waiting for kernels 415 to become available).

Note that just because kernel assignment unit 445 may have assigned a particular scan 510 of FIG. 5 to a particular kernel 415, that fact does not mean that that kernel 415 will ultimately execute that scan 510 of FIG. 5. As discussed further below, ultimately it is the database management system cost function that may determine what scan function to apply. If the scan function selected by the database management cost function is not supported by kernel 415 assigned to scan 510 of FIG. 5 by kernel assignment unit 445, then scan 510 of FIG. 5 may be performed in software, even though kernel 415 was assigned to scan 510 of FIG. 5 by kernel assignment unit 445. Thus, the database management system cost function may ultimately be responsible for determining whether scan 510 of FIG. 5 is performed by kernel 415 or in software (for example, running on processor 110 of FIG. 1).

As another example of why kernel assignment unit 445 might not assign all available kernels 415 to scan 510 of FIG. 5, kernel assignment unit 445 might recognize that there might be an upper bound on the number of kernels 415 that might expedite a particular scan 510 of FIG. 5, and applying additional kernels to a single scan 510 of FIG. 5 might not be worthwhile. For example, consider the situation where a single query 505 of FIG. 5 is pending, with only one scan 510 of FIG. 5 in query 505 of FIG. 5. Further, assume that table 410 is relatively small: for example, only one block of data (which might be processed by kernel 415 in a single iteration of the implemented scan algorithm). Priority 615 of FIG. 6 for this scan 510 of FIG. 5 might therefore be relatively low.

Since scan 510 of FIG. 5 is the only scan 510 of FIG. 5 being considered, whether priority 615 of FIG. 6 is low or high might be considered irrelevant: scan 510 of FIG. 5 might still be assigned all available kernels 415. But since table 410 is relatively small, there might be little or no benefit to assigning multiple kernels 415 to scan 510 of FIG. 5: a single kernel 415 might be sufficient. In that situation, kernel assignment unit 445 might only assign some (or one) of the available kernels 415 to scan 510 of FIG. 5 rather than assigning all available kernels 415 to scan 510 of FIG. 5.

As mentioned above, while kernel assignment unit 445 may assign kernels 415 to scans 510 of FIG. 5, the fact that kernels 415 are assigned to scans 510 of FIG. 5 does not guarantee that kernels 415 are actually used to execute scans 510 of FIG. 5. Kernels 415 may implement a particular scan function. But the database management system might have multiple different scan algorithms that may be used, and may use a cost function to decide which scan algorithm is considered the best choice for an individual scan 510 of FIG. 5. A scan algorithm implemented by kernel 415 might represent only one such function, and might not be selected as the lowest cost function to use.

If the database management system cost function does not select kernels 415 to execute scan function for a particular scan 510 of FIG. 5, then kernels 415 are not actually used. Thus, kernels 415 may only be allocated to execute a particular scan 510 of FIG. 5 if the database management system cost function selects the scan algorithm implemented by kernels 415. This allocation is handled by kernel allocation unit 450. Kernel allocation unit 450 may instruct kernel 415 to actually begin executing scan 510 of FIG. 5 once the database management system cost function has selected the scan implemented by kernel 415 to execute scan 510 of FIG. 5. In some embodiments of the disclosure, kernel allocation unit 450 may also notify kernel release unit 455, discussed further below, that a particular kernel 415 that was assigned to scan 510 of FIG. 5 was not allocated to scan 510 of FIG. 5, and may be released.

Note that there is a difference between kernel assignment and kernel allocation: kernel assignment may involve reserving a kernel for use for a particular scan 510 of FIG. 5, whereas kernel allocation may involve actually using the kernel to execute scan 510 of FIG. 5. This distinction may thought of as analogous to the difference between making a reservation at a restaurant to eat dinner and showing up at the restaurant at the time of the reservation to cat dinner: the former ensures that a table is waiting for the diner, but the diner does not actually use the table until the diner shows up at the restaurant. Similarly, that kernel assignment unit 445 assigns kernel 415 to scan 510 of FIG. 5 does not ensure that kernel 415 is used to execute scan 510 of FIG. 5: kernel 415 might only be used to execute scan 510 of FIG. 5 after kernel allocation unit 450 allocates kernel 415 to execute scan 510 of FIG. 5, which may depend on the database management system cost function selecting the scan algorithm implemented by kernel 415 to perform scan 510 of FIG. 5.

Part of the complication is that in some embodiments of the disclosure, the database management cost function might not be aware that kernels 415 are available to execute scans 510 of FIG. 5. After all, if there are no kernels 415 available to execute scans 510 of FIG. 5, then there is no point in the database management system cost function considering kernels 415 to execute scans 510 of FIG. 5. But even if kernels 415 are available, that fact does not necessarily mean that kernels 415 may be used to execute scans 510 of FIG. 5. As discussed above, prioritizing which scans 510 of FIG. 5 might be executed by kernels 415 means that kernels 415 might or might not be available for any individual scan 510 of FIG. 5. In addition, depending on the scan function implemented by kernels 415, even if kernels 415 are available, kernels 415 might not be the optimal choice for a particular scan 510 of FIG. 5. Thus, the database management system cost function might not assume that any particular scan 510 of FIG. 5 should be executed by kernels 415. In other words, in some embodiments of the disclosure, assignment of kernels 415 to scans 510 of FIG. 5 may precede execution of the database management system cost function, so that the database management system cost function only considers scan functions that are actually available to carry out scans 510 of FIG. 5, which is why kernel allocation unit 450 may be performed when it is time to execute scans 510 of FIG. 5.

As discussed above, some data from table 410 might be in cache 430. Assuming that accelerator 135 does not have access to cache 430 (or accessing data from cache 430 might be slower than accessing data from storage device 120 due to distance or access protocols), it may be important to ensure that any data in cache 430 is flushed to storage device 120 before kernels 415 execute scan 510 of FIG. 5. Cache flush unit 460 may trigger the flushing of any data from cache 430 (again, as discussed above, this may involve flushing data from either a cache In the database management system or in the operating system of machine 105 of FIG. 1), to ensure that accelerator 135 (and more particularly, kernels 415) may access the most current data from table 410. But since kernel 415 may only need access to the data if kernel 415 executes scan 510 of FIG. 5, there may be a link between kernel allocation unit 450 and cache flush unit 460: cache flush unit 460 might not be invoked if kernel 415 is not allocated to scan 510 of FIG. 5 by kernel allocation unit 450. Put another way, invoking cache flush unit 460 may be the last operation (or one of the last operations) before kernels 415 begin executing scan 510 of FIG. 5 of table 410.

The flushing of data from cache 430 back to storage device 120 might involve both writing any dirty data back to storage device 120, as well as removing any clean data (that is, data that is valid but has not been updated) from cache 430. By writing dirty data back to storage device 120, kernels 415 may be ensured to have access to the most current data, including any updates that might have been made by clients. By deleting any clean data from cache 430, cache flush unit 460 may ensure that any clients may have to retrieve data from database 405 fresh, again to ensure that all clients are working from the same data (and to protect against clients updating cached data to which kernel 415 might not have access).

There is another potential consequence of accelerator 135 not having access to cache 430. This other consequence is that cache flush unit 460 might not be able to selectively flush particular blocks (or other units of data) from cache 430. Thus, in some embodiments of the disclosure, cache flush unit 460 might trigger all data in cache 430 being flushed to storage device 120. But in other embodiments of the disclosure, cache flush unit 460 might be able to specify what data is flushed from cache 430 back to storage device 120: for example, cache flush unit 460 might be able to specify that only data for table 410 be flushed back to storage device 120, with any data from other tables being left in cache 430. In such embodiments of the disclosure, dirty data for table 410 in cache 430 may be flushed to storage device 120, and clean data for table 410 may be deleted from cache 430, but data for other tables might be left in place. Such a more selective approach may permit clients to continue to update data in cache 430 where such updates might not affect scans 510 of FIG. 5 being executed by kernels 415.

In yet other embodiments of the disclosure, cache flush unit 460 might only write dirty data for table 410 back to storage device 120, but leave clean data for table 410 in cache 430. Leaving clean data for table 410 in cache 430 may permit faster access to such data for other scans or clients. But in such embodiments of the disclosure, it might be important to flag the clean data for table 410 in cache 430, so that if any clients attempt to update the data for table 410 in cache 430 such updates are directed to storage device 120 instead (to ensure that kernels 415 continue to have access to the most current data for table 410). Such embodiments of the disclosure may involve setting a bit in cache 430 to indicate that particular blocks (or other units of data) are not writeable (at least for the duration of scan 510 of FIG. 5 being executed by kernel 415: such a bit may be reset when kernel 415 completes scan 510 of FIG. 5) to ensure that the updated data is instead written to storage device 120. In addition, if this flag is set, cache 430 may be aware that after the update operation completes the block (or other unit of data) in cache 430 may need to be refreshed.

Finally, kernel release unit 455 may release kernels 415 that are not being used to execute scans 510 of FIG. 5. One way in which kernel 415 might be released is if kernel 415 finishes executing scan 510 of FIG. 5: once kernel 415 has finished executing scan 510 of FIG. 5, kernel 415 may be used for another scan 510 of FIG. 5 and may be released. But recall that the database management cost function might not select the scan algorithm implemented by kernel 415 to execute scan 510 of FIG. 5: the database management system cost function might select a different scan algorithm (other than kernel 415) to execute scan 510 of FIG. 5. In this situation, kernel 415 may also be released, so that kernel 415 may be available for assignment to other scans 510 of FIG. 5.

When kernel 415 has been allocated to scan 510 of FIG. 5, determining when kernel 415 has finished executing scan 510 of FIG. 5 may be as simple as determining that kernel 415 is no longer actively executing instructions. (Alternatively, kernel 415 may send a signal to kernel release unit 455 upon completing its execution of scan 510 of FIG. 5, to let kernel release unit 455 know that kernel 455 is again available.) But determining that kernel 415 was assigned to scan 510 of FIG. 5 but was not allocated to scan 510 of FIG. 5 (for example, because the database management system cost function selected a different scan function to scan table 410) is a different problem: a kernel 415 that is not currently executing scan 510 of FIG. 5 might simply be waiting to begin, rather than not be allocated.

There are various possible solutions to address this situation. In some embodiments of the disclosure, kernel allocation unit 450 may notify kernel release unit 455 when kernel 415 that was assigned to scan 510 of FIG. 5 was not actually allocated to scan 510 of FIG. 5. In other embodiments of the disclosure, kernel assignment unit 445 may associate a timestamp with the assignment of kernel 415 to scan 510 of FIG. 5. Then, when kernel release unit 455 executes, it may compare the timestamp associated with the assignment of kernel 415 to scan 510 of FIG. 5 with a current timestamp. If the difference between the timestamps is greater than a threshold difference, then kernel release unit 455 may conclude that kernel 415 was not allocated by kernel allocation unit 450 and may be released to be available for other scans 510 of FIG. 5.

Kernel release unit 455 might operate by maintaining a table of which kernels 415 are currently assigned to scans 510 of FIG. 5, and which kernels 415 are currently available to be assigned to other scans 510 of FIG. 5. Note that only one bit might be needed per kernel 415 in such embodiments of the disclosure, minimizing the amount of storage needed. This table may be updated to set a flag when kernel assignment unit 445 assigns a kernel 415 to scan 510 of FIG. 5, and may be reset by kernel release unit 455 when the kernel 415 has completed executing the scan 510 of FIG. 5. Note that kernel release unit 455 may also maintain other information in the table, such as the timestamp of when kernel assignment unit 445 assigned kernel 415 to scan 510 of FIG. 5. As discussed above and further with reference to FIG. 8 below, this timestamp may be used to determine that kernels 415 that were assigned to scans 510 of FIG. 5 were not allocated to such scans 510 of FIG. 5 based on being idle for a threshold amount of time.

FIG. 7 shows kernels 415 of FIG. 4 being assigned to scans 510 of FIG. 5 according to scan priorities 615 of FIG. 6, according to embodiments of the disclosure. In FIG. 7, four scans 510-1 through 510-4 are shown, each with a corresponding priority 615-1 through 615-4 (which may be referred to collectively as priorities 615). FIG. 7 also shows five kernels 415-1 through 415-5. While FIG. 7 shows four scans 510 and five kernels 415, embodiments of the disclosure may include any number of scans 510 and any number of kernels 415: the four scans 510 and five kernels 415 shown in FIG. 7 are merely an example.

Summing priorities 615 produces a total of 36 (12+12+8+4). This means that of the five kernels 415, scans 510-1 and 510-2 may each be assigned two of kernels

$$415 ( 5 \times \frac{12}{36} = 5 / 3 \approx 1.67 ,$$

which rounds up to two). Scan 510-3 may be assigned one of kernel

$$415 ( 5 \times \frac{8}{36} = \frac{10}{9} \approx 1.11 ,$$

which rounds down to one). Scan 510-4 may be assigned none kernels

$$415 ( 5 \times \frac{4}{36} = 5 / 9 \approx 0.56 ,$$

which would round up to one, but all of kernels 415 have already been assigned), and may fall back on using a database software scan function.

It is worth noting that more than scans 510-1 and 510-2 each have more than one kernel 415 assigned to them. This might beg the question: how might two kernels 415 be used for a single scan? The answer is that each of kernels 415-1 through 415-4 might process part of the data in scans 510-1 and 510-2, which may expedite overall execution of scans 510-1 and 510-2.

FIG. 8 shows kernel release unit 455 of FIG. 4 determining when to release kernels 415 of FIG. 4, according to embodiments of the disclosure. In FIG. 8, kernel release unit 455 is shown as receiving timestamps 805-1 and 805-2 (which may be referred to collectively as timestamps 805) and threshold 810. Timestamp 805-1 may represent the timestamp when kernel assignment unit 445 of FIG. 4 assigned kernel 415 of FIG. 4 to scan 510 of FIG. 5, and which may be stored, for example, in a table managed by kernel release unit 455. Timestamp 805-2 may represent a more current timestamp: for example, the timestamp when kernel release unit 455 was invoked. From timestamps 805-1 and 805-2, kernel release unit 455 may determine a difference, and may compare that difference with threshold 810. If the difference between timestamps 805-1 and 805-2 satisfies threshold 810 (for example, if the difference between timestamps 805-1 and 805-2 is greater than threshold 810), then kernel release unit 455 may conclude that kernel 415 of FIG. 4 has been waiting long enough and may be released to be available to execute another scan 510 of FIG. 5. Note that the difference may “satisfy” threshold 810 in any desired manner: for example, the difference might be less than, less than or equal to, greater than, or greater than or equal to threshold 810 to “satisfy” threshold 810.

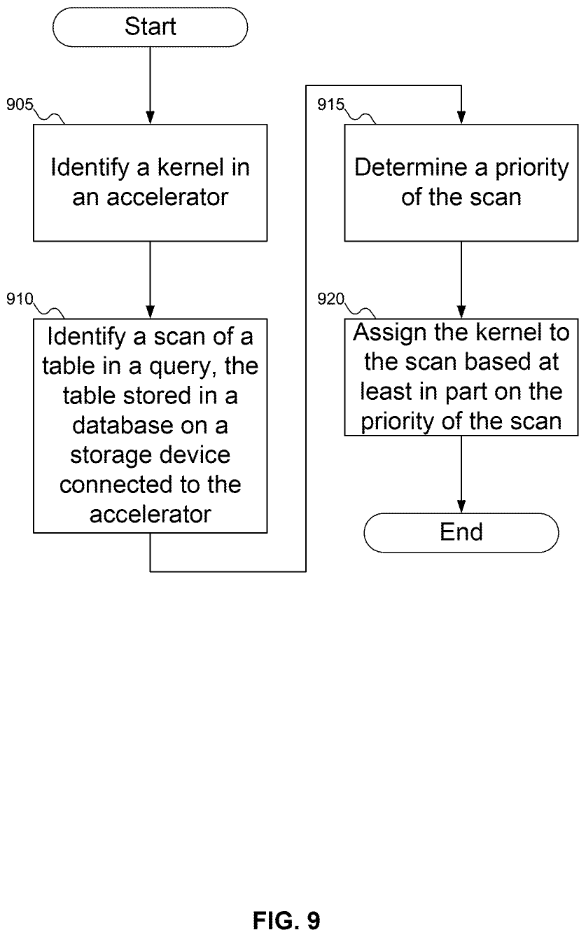

FIG. 9 shows a flowchart of an example procedure for accelerator 135 of FIG. 1 to assign kernels 415 of FIG. 4 to scans 510 of FIG. 5, according to embodiments of the disclosure. In FIG. 9, at block 905, accelerator 135 of FIG. 1 may identify kernel 415 of FIG. 4. In this context, to “identify” kernel 415 of FIG. 4 may be understood to mean to recognize that a particular kernel 415 of FIG. 4 may be available to process scan 510 of FIG. 5 in query 505 of FIG. 5, perhaps using some identifier associated with that kernel 415 of FIG. 4 (and which may distinguish that kernel 415 of FIG. 4 from any other kernel 415 of FIG. 4). For example, if different kernels 415 of FIG. 4 may implement different scan algorithms, and only some of those scan algorithms may be applicable to scan 510 of FIG. 5, then only kernel(s) 415 of FIG. 4 that implement the applicable scan algorithms may be identified at block 905. Note, too, that accelerator 135 of FIG. 1 may identify more than one kernel 415 of FIG. 4 at block 905, as might occur if more than one kernel 415 of FIG. 4 may be assigned to scan 510 of FIG. 5.

At block 910, query retrieval unit 425 of FIG. 4 may identify scan 510 of FIG. 5 in query 505 of FIG. 5. Scan 510 of FIG. 5 may access data from table 410 of FIG. 4, stored in database 405 of FIG. 4 on storage device 120 of FIG. 1, to which accelerator 135 of FIG. 1 may be connected. Note that query 505 of FIG. 5 may include more than one scan 510 of FIG. 5, which means that query retrieval unit 425 of FIG. 4 might identify more than one scan 510 of FIG. 5 at block 910. At block 915, scan priority calculator 440 of FIG. 4 may determine priority 615 of FIG. 6 for scan 510 of FIG. 5 (or for each scan 510 of FIG. 5, if more than one scan 510 of FIG. 5 was identified by query retrieval unit 425 of FIG. 4 in block 910). Finally, at block 920, kernel assignment unit 445 of FIG. 4 may assign kernel 415 of FIG. 4 to scan 510 of FIG. 5 based on priority 615 of FIG. 6 (or, more generally, to assign one or more kernels 415 of FIG. 4 to one or more scans 510 of FIG. 5).

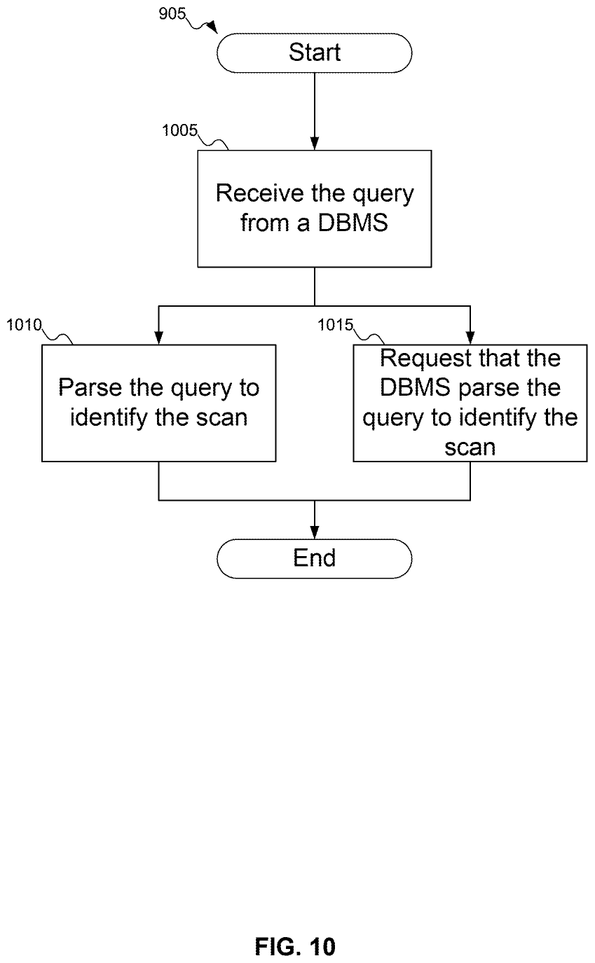

FIG. 10 shows a flowchart of an example procedure for accelerator 135 of FIG. 1 to identify scans 510 of FIG. 5, according to embodiments of the disclosure. In FIG. 10, at block 1005, query retrieval unit 425 of FIG. 4 may retrieve query 505 of FIG. 5 from database 405 of FIG. 4. At block 1010, query retrieval unit may use its own parser to parse query 505 and identify scan 510 of FIG. 5. Alternatively, at block 1015, query retrieval unit 425 of FIG. 4 may request database 405 of FIG. 4 to parse query 505 of FIG. 5 to identify scan 510 of FIG. 5.

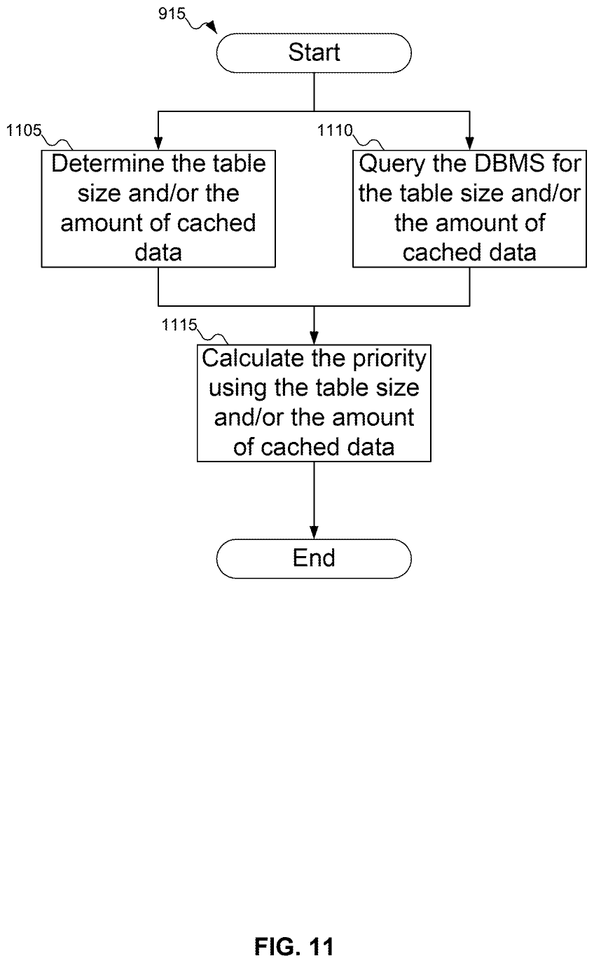

FIG. 11 shows a flowchart of an example procedure for accelerator 135 of FIG. 1 to determine scan priorities 615 of FIG. 6 for scans 510 of FIG. 5, according to embodiments of the disclosure. In FIG. 11, at block 1105, cache query unit 435 of FIG. 4 may determine size 605 of FIG. 6 of table 410 of FIG. 4 accessed by scan 510 of FIG. 5. Cache query unit 435 of FIG. 4 may also determine size 610 of FIG. 6 of the amount of data from table 410 of FIG. 4 currently cached in cache 430 of FIG. 4. Note that size 610 of FIG. 6 of the amount of data from table 410 of FIG. 4 currently cached in cache 430 of FIG. 4 may include both the amount of dirty data from table 410 of FIG. 4 in cache 430 of FIG. 4 as well as the amount of valid (clean) data from table 410 of FIG. 4 in cache 430 of FIG. 4. Cache query unit 435 of FIG. 4 may also determine the amounts of dirty and clean data from table 410 of FIG. 4 in cache 430 of FIG. 4 separately rather than together. Alternatively, at block 1110, cache query unit 435 of FIG. 4 may query database 405 of FIG. 4 for these data. Finally, at block 1115, scan priority calculator 440 of FIG. 4 may calculate priority 615 of FIG. 6 for scan 510 of FIG. 5 based on size 605 of FIG. 6 of table 410 and size 610 of FIG. 6 of the amount of data currently cached in cache 430 of FIG. 4.

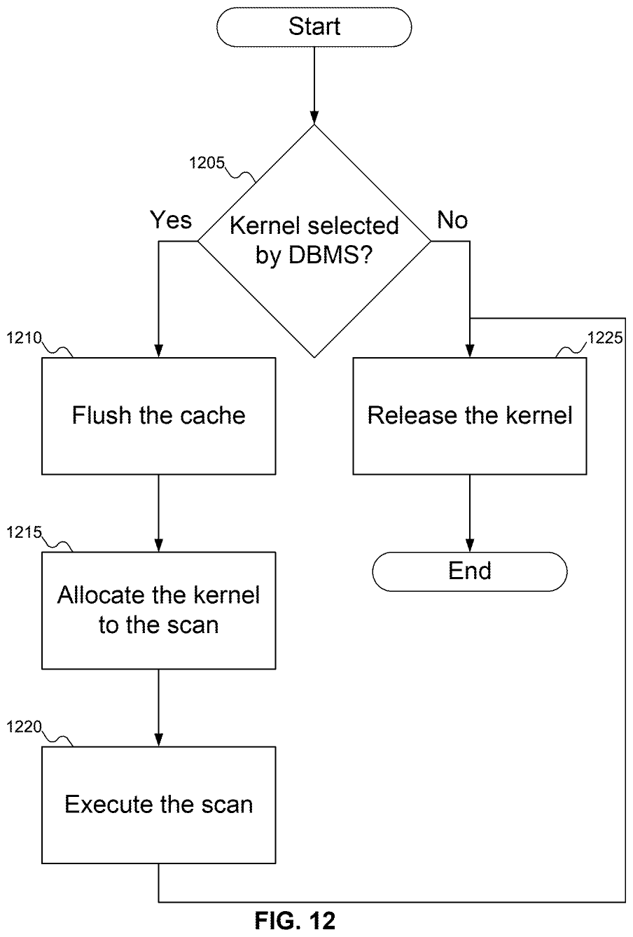

FIG. 12 shows a flowchart of an example procedure for accelerator 135 of FIG. 1 to use kernels 415 of FIG. 4 to execute scans 510 of FIG. 5 and to release kernels 415 of FIG. 4, according to embodiments of the disclosure. In FIG. 12, at block 1205, accelerator 135 of FIG. 1 may determine whether the database management system cost function has selected kernel 415 of FIG. 4 to execute scan 510 of FIG. 5. If so, then at block 1210, cache flush unit 460 of FIG. 4 may flush cache 430 of FIG. 4, at block 1215, kernel allocation unit 450 of FIG. 4 may allocate kernel 415 of FIG. 4 to scan 510, and at block 1220, kernel 415 of FIG. 4 may execute scan 510 of FIG. 5. Finally, at block 1225, kernel release unit 455 of FIG. 4 may release kernel 415 of FIG. 4 back to the pool of available kernels.

If the database management system cost function does not select kernel 415 of FIG. 4 to execute scan 510 of FIG. 5, then processing may proceed directly to block 1225 for kernel release unit 455 of FIG. 4 to release kernel 415 of FIG. 4 back to the pool of available kernels.

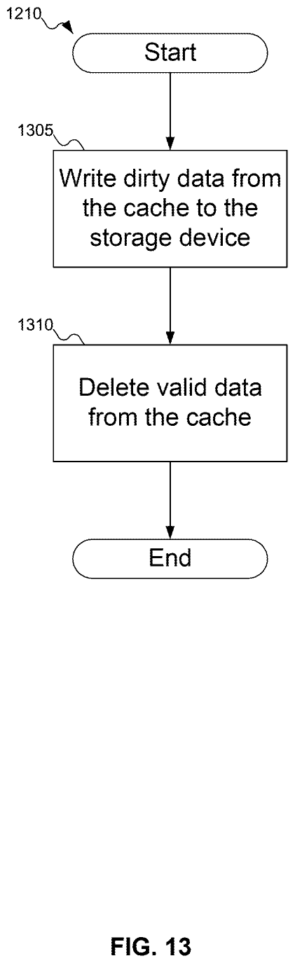

FIG. 13 shows a flowchart of an example procedure for accelerator 135 of FIG. 1 to flush cache data, according to embodiments of the disclosure. In FIG. 13, at block 1305, cache flush unit 460 of FIG. 4 may request that any dirty data for table 410 of FIG. 4 in cache 430 of FIG. 4 be written back to storage device 120 of FIG. 1. Then, at block 1310, cache flush unit 460 of FIG. 4 may request that any valid (clean) data for table 410 of FIG. 4 be deleted from cache 430 of FIG. 4. Note that if cache flush unit 460 of FIG. 4 may access cache 430 of FIG. 4 itself, then cache flush unit 460 of FIG. 4 may perform these operations directly, without asking other elements, such as the database management system or the operating system, to perform such operations.

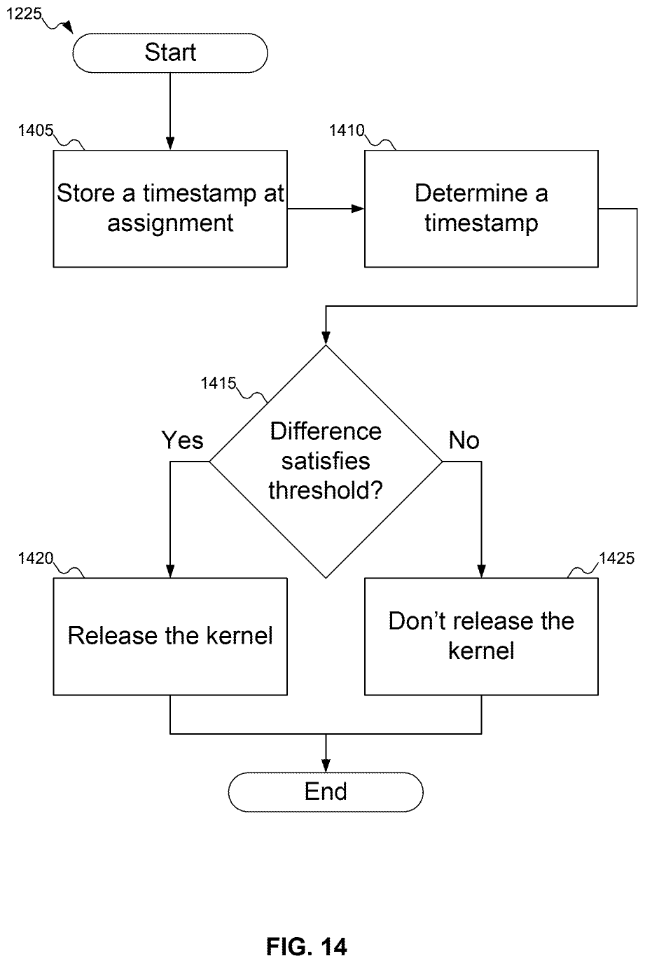

FIG. 14 shows a flowchart of an example procedure for accelerator 135 of FIG. 1 to determine whether kernel 415 of FIG. 4 that has been assigned to scan 510 of FIG. 5 but has not been allocated to scan 510 of FIG. 5 may be released, according to embodiments of the disclosure. In FIG. 14, at block 1405, kernel assignment unit 445 of FIG. 4 may access timestamp 805-1 of FIG. 8 associated with the assignment of kernel 415 of FIG. 4 to scan 510 of FIG. 5. At block 1410, kernel release unit 455 of FIG. 4 may determine timestamp 805-2 of FIG. 8, which may represent the current time of machine 105 of FIG. 1. At block 1415, kernel release unit 455 of FIG. 4 may determine the difference between timestamps 805-1 of FIG. 8 and 805-2 of FIG. 8, and may determine whether the difference satisfies threshold 810 of FIG. 8. If so, then at block 1420, kernel release unit 455 of FIG. 4 may release kernel 415 of FIG. 4 back to the pool of available kernels; otherwise, at block 1425, kernel release unit 455 of FIG. 4 may leave kernel 415 of FIG. 4 assigned to scan 510 of FIG. 5.

In FIGS. 9-14, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

Embodiments of the disclosure may support determining priorities for scans of queries issued by clients to a database. By determining priorities for the scans, kernels in an accelerator may be assigned to the scans in proportion to the priorities of the scans. By assigning kernels to scans in proportion to the priorities of the scans, some kernels might be assigned to different scans, providing for improved processing of multiple scans using the kernels. This approach provides a technical advantage over simply assigning all kernels in the accelerator to the first scan encountered in the queries.

Embodiments of the disclosure include a mechanism for managing tail latency across multiple queries and support fair distribution of the scan kernels among parallel scans. Embodiments of the disclosure avoid assigning all the scan kernels to one scan, leading to one scan acquiring all the resources and other possible parallel scans to fall back to DataBase Management System (DBMS) native scan algorithms regardless of their need for resources. Embodiments of the disclosure may also support scans that are aware of the DBMS/Operating System (OS) cache updates: embodiments of the disclosure may therefore avoid reading from the disk data that was not yet updated to the disk. Embodiments of the disclosure may also enable different database clients to access the updated kernel information, their availability, and real-time assignments. Embodiments of the disclosure may also consider the relation that is going to be scanned in cache. Falling back to the DBMS scan algorithms when most of the relation is available in the cache may have significant impact on the performance.

To find the queries that are being executed at the current time, the DBMS cumulative statistics system may be queried. Having access to the raw queries in the system, the DBMS internal parser may be used to extract the relations that need to be scanned. Among these scan candidates, the cache statistics for each relation may be acquired. Then, a priority value may be calculated for each scan based on the relation size and the cache statistics for each relation:

Priority=relation.blocks−relation.cache.valid−relation.cache.dirty

These parameters and how they are used to generate the priority score may be subject to testing and tuning based on the different scenarios, use cases, and the status of the system. In some embodiments of the disclosure, the priority function may assign a score of zero to the relations for which most of their blocks are valid or dirty or their number of dirty pages is greater than a specific threshold:

If relation.cache.dirty+relation.cache.valid>relation.blocks/2∥relation.cache.dirty>MAX_DIRTY then priority=0;

After that, the available kernels may be distributed to the scans in proportion to their priority:

Number of kernels assigned to relation=(number of available kernels*relation priority)/sum of priorities for all the processed relations

The kernel assignment function may be called by every scan in the planner stage. This function analyzes all the relation in all the queries that are currently running in the system but have not been analyzed before. As a result, it is possible that a kernel assignment call by a single scan may assign kernels to other scans. However, if the kernel assignment is already done for the scan that is calling the function during function calls by previous scans, the assignment is not done again. Also, the assignment might not be done if there is no available kernel in the system. This function may be protected by a mutex lock, so, when there are multiple simultaneous queries, the first to acquire the lock runs the function and lets it decide for all the present scans in the system.

In summary, the kernel assignment function does the following:
Acquire a lock
Release stalled kernels (these are the kernels that have been assigned to scans previously and have not been claimed after a specific amount of time, possibly because of cost function bidding lost)
Calculate and assign the kernels to all the available scans in the system that have not previously been assigned a kernel.

### Cache Scan

Caching information for specific relations might not be directly available. To determine the number of valid, dirty, or invalid blocks of a relation, for each block of the relation, the DBMS cache system may be queried. Given the cache information for the specific block of the specific relation, embodiments of the disclosure may loop through all the blocks and gather information about all of them. In the cache scan, the number of dirty pages of the relation and the number of valid pages of the relation may be identified. Since it might not be possible to flush specific pages of a relation, embodiments of the disclosure may track only the number of dirty and valid pages of the relation in the cache, rather than tracking the specific dirty and valid pages of the relation in the cache. But in some embodiments of the disclosure, the specific dirty and valid pages of the relation in the cache may be tracked.

After the cache is scanned for a relation, the statistics may be stored in a shared memory. There are several reasons to do this. First, other relations might issue a kernel calculation mechanism to have access to this information. Second, this information may be reused for later scans of this relation. In a system in which scans are more frequent than writes, reusing relations that have been scanned previously may reduce the resources used. Embodiments of the disclosure may use a counter to indicate how many times cache statistics for a relation have been used without rescanning the cache for it. Basically, embodiments of the disclosure may keep a local cache of the cache statistics for each relation.

### Flushing Dirty Pages

Before initiating the scan (execution init stage), the dirty pages of a relation may be flushed so that the most updated version of that relation is scanned. In this stage, cache statistics for the relation may be checked: if the relation is already available and is not expired, the relation may be used to find out whether or not there are any dirty pages and whether or not there is need for cache flushing. If the relation is not available or expired, the cache may be scanned for that relation: the gathered statistics may then be used to decide whether or not to flush the cache. Cache flushing may be done through two different calls: one for flushing the DBMS cache and one for flushing the OS cache.

### Handling Fallbacks Caused by the Cost Function

The cost function for a scan is called in the planning stage. In this stage, the cost bidding by a scan API and other scan algorithms may be determined, and the algorithm with the lower/lowest cost may be used to perform the scan. But because other scans may also be attempting to use resources, embodiments of the disclosure might result in some scans not being assigned the requested resources. Basically, in the planning stage, embodiments of the disclosure may decide how many kernels are to be allocated to a scan and those kernels may be reserved. Embodiments of the disclosure may expect to allocate these kernels later in the execution init stage. But if the scan API loses the cost bidding to another scan algorithm, the execution init stage might not be called and embodiments of the disclosure may not be aware that those kernels should be unreserved to be used for other scans. Embodiments of the disclosure may therefore track the time kernels are reserved for a scan. Whenever kernel allocation is performed, embodiments of the disclosure may check for scans that have reserved kernels, but have not claimed them. If a threshold amount of time has passed, those kernels may be unreserved.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Embodiments of the disclosure may extend to the following statements, without limitation:
Statement 1. An embodiment of the disclosure includes an apparatus, comprising:
a storage device, the storage device storing a database including a table; and
an accelerator connected to the storage device, the accelerator including a kernel;
a scan priority calculator to calculate a priority of a scan of the table in the database stored on the storage device, the scan associated with a query; and
a kernel assignment unit to assign the kernel to the scan based at least in part on the priority of the scan.
Statement 2. An embodiment of the disclosure includes the apparatus according to statement 1, wherein the apparatus is part of a database management system.
Statement 3. An embodiment of the disclosure includes the apparatus according to statement 1, further comprising a receiver to receive the query from a client.
Statement 4. An embodiment of the disclosure includes the apparatus according to statement 1, wherein the accelerator is separate from the storage device.
Statement 5. An embodiment of the disclosure includes the apparatus according to statement 1, wherein the apparatus integrates the storage device and the accelerator.
Statement 6. An embodiment of the disclosure includes the apparatus according to statement 1, wherein the accelerator includes the scan priority calculator and the kernel assignment unit.
Statement 7. An embodiment of the disclosure includes the apparatus according to statement 1, wherein the accelerator further includes a second kernel.
Statement 8. An embodiment of the disclosure includes the apparatus according to statement 1, wherein the scan priority calculator is configured to calculate the priority of the scan based at least in part on a first size of the table or a second size of an amount of data from the table in a cache.
Statement 9. An embodiment of the disclosure includes the apparatus according to statement 8, wherein the cache includes a first cache of a database management system or a second cache or an operating system.
Statement 10. An embodiment of the disclosure includes the apparatus according to statement 8, further comprising a cache query unit to determine the second size of the amount of the data from the table in the cache.
Statement 11. An embodiment of the disclosure includes the apparatus according to statement 10, wherein the cache query unit is configured to query a database management system to determine the first size of the table or the second size of the amount of the data from the table in the cache.
Statement 12. An embodiment of the disclosure includes the apparatus according to statement 1, wherein the scan priority calculator includes a query retrieval unit to retrieve the query from a database management system.
Statement 13. An embodiment of the disclosure includes the apparatus according to statement 1, wherein the kernel assignment unit is configured to assign the kernel to the scan of the scan and a second scan based at least in part on the priority of the scan and a second priority of the second scan.
Statement 14. An embodiment of the disclosure includes the apparatus according to statement 13, wherein the second scan is associated with the query.
Statement 15. An embodiment of the disclosure includes the apparatus according to statement 13, wherein the second scan is associated with a second query.
Statement 16. An embodiment of the disclosure includes the apparatus according to statement 1, wherein the scan priority calculator includes a parser to parse the query to identify the scan.
Statement 17. An embodiment of the disclosure includes the apparatus according to statement 1, wherein:
a database management system includes a parser to parse the query to identify the scan; and
the scan priority calculator is configured to use the parser of the database management system.
Statement 18. An embodiment of the disclosure includes the apparatus according to statement 1, further comprising a cache flush unit to flush a first cache of a database management system or a second cache of an operating system to the storage device.
Statement 19. An embodiment of the disclosure includes the apparatus according to statement 18, wherein the cache flush unit is configured to write dirty data from the first cache of the database management system or the second cache of the operating system to the storage device.
Statement 20. An embodiment of the disclosure includes the apparatus according to statement 18, wherein the cache flush unit is configured to delete valid data from the first cache of the database management system or the second cache of the operating system.
Statement 21. An embodiment of the disclosure includes the apparatus according to statement 18, wherein the cache flush unit is configured to execute based at least in part on the database management system selecting the kernel to execute the scan.
Statement 22. An embodiment of the disclosure includes the apparatus according to statement 1, further comprising a kernel release unit to release the kernel based at least in part on a completion of the scan.
Statement 23. An embodiment of the disclosure includes the apparatus according to statement 1, further comprising a kernel allocation unit to allocate the kernel to the scan.
Statement 24. An embodiment of the disclosure includes the apparatus according to statement 23, wherein the kernel allocation unit is configured to allocate the kernel to the scan based at least in part on a database management system selecting the kernel to execute the scan.
Statement 25. An embodiment of the disclosure includes the apparatus according to statement 1, further comprising a kernel release unit configured to release the kernel based at least in part on a database management system selecting a software to execute the scan.
Statement 26. An embodiment of the disclosure includes the apparatus according to statement 25, wherein:
the kernel assignment unit is configured to associate a first timestamp with the kernel and the scan; and
the kernel release unit is configured to release the kernel based at least in part on a threshold difference between the first timestamp and a second timestamp.
Statement 27. An embodiment of the disclosure includes a method, comprising:
identifying a kernel in an accelerator;
identifying a scan of a table in a query, the table stored in a database on a storage device connected to the accelerator;
determining a priority of the scan; and
assigning the kernel to the scan based at least in part on the priority of the scan.
Statement 28. An embodiment of the disclosure includes the method according to statement 27, wherein the accelerator is part of a database management system.
Statement 29. An embodiment of the disclosure includes the method according to statement 27, wherein the accelerator is separate from the storage device.
Statement 30. An embodiment of the disclosure includes the method according to statement 27, wherein the accelerator and the storage device are integrated into a single apparatus.
Statement 31. An embodiment of the disclosure includes the method according to statement 27, wherein identifying the scan of the table in the query includes receiving the query from a client.
Statement 32. An embodiment of the disclosure includes the method according to statement 31, wherein receiving the query from the client includes retrieving the query from a database management system.
Statement 33. An embodiment of the disclosure includes the method according to statement 32, wherein the database management system receives the query from the client.
Statement 34. An embodiment of the disclosure includes the method according to statement 27, wherein identifying the scan of the table in the query includes parsing the query to identify the scan of the table.
Statement 35. An embodiment of the disclosure includes the method according to statement 27, wherein identifying the scan of the table in the query includes identifying the scan of the table in the query using a database management system.
Statement 36. An embodiment of the disclosure includes the method according to statement 27, wherein determining the priority of the scan includes calculating the priority of the scan based at least in part on a first size of the table or a second size of an amount of data from the table in a cache.
Statement 37. An embodiment of the disclosure includes the method according to statement 36, wherein the cache includes a first cache of a database management system or a second cache or an operating system.
Statement 38. An embodiment of the disclosure includes the method according to statement 36, wherein determining the priority of the scan further includes determining the first size of the table or the second size of the amount of data from the table in the cache.
Statement 39. An embodiment of the disclosure includes the method according to statement 38, wherein determining the first size of the table and the second size of the amount of data from the table in the cache includes querying a database management system for the first size of the table or the second size of the amount of data from the table in the cache.
Statement 40. An embodiment of the disclosure includes the method according to statement 27, wherein:
identifying the kernel in the accelerator includes identifying the kernel and a second kernel in the accelerator;
assigning the kernel to the scan based at least in part on the priority of the scan includes assigning the kernel and the second kernel to the scan based at least in part on the priority of the scan.
Statement 41. An embodiment of the disclosure includes the method according to statement 27, wherein:
identifying the scan of the table in the query includes identifying the scan of the table and a second scan of a second table in the query;
determining the priority of the scan includes determining the priority of the scan and a second priority for the second scan; and
assigning the kernel to the scan or the second scan based at least in part on the priority of the scan and the second priority of the second scan.
Statement 42. An embodiment of the disclosure includes the method according to statement 27, further comprising executing the scan using the kernel.
Statement 43. An embodiment of the disclosure includes the method according to statement 42, wherein executing the scan using the kernel includes flushing a first cache of a database management system or a second cache of an operating system.
Statement 44. An embodiment of the disclosure includes the method according to statement 43, wherein flushing the first cache of the database management system or the second cache of the operating system includes writing dirty data from the first cache of the database management system or the second cache of the operating system to the storage device.
Statement 45. An embodiment of the disclosure includes the method according to statement 43, wherein flushing the first cache of the database management system or the second cache of the operating system includes deleting valid data from the first cache of the database management system or the second cache of the operating system.
Statement 46. An embodiment of the disclosure includes the method according to statement 43, wherein flushing the first cache of the database management system or the second cache of the operating system includes flushing the first cache of the database management system or the second cache of the operating system based at least in part on the database management system selecting the kernel to execute the scan.
Statement 47. An embodiment of the disclosure includes the method according to statement 42, wherein executing the scan using the kernel includes determining that the database management system selects the kernel to execute the scan.
Statement 48. An embodiment of the disclosure includes the method according to statement 47, wherein executing the scan using the kernel further includes allocating the kernel to the scan.
Statement 49. An embodiment of the disclosure includes the method according to statement 27, further comprising releasing the kernel based at least in part on a database management system selecting a software to execute the scan.
Statement 50. An embodiment of the disclosure includes the method according to statement 49, wherein:
assigning the kernel to the scan based at least in part on the priority of the scan includes storing a first timestamp; and
releasing the kernel based at least in part on the database management system selecting the software to execute the scan includes:
   determining a second timestamp; and
   determining that a difference between the first timestamp and the second timestamp exceeds a threshold difference.
Statement 51. An embodiment of the disclosure includes an article, comprising a non-transitory storage medium, the non-transitory storage medium having stored thereon instructions that, when executed by a machine, result in:
identifying a kernel in an accelerator;
identifying a scan of a table in a query, the table stored in a database on a storage device connected to the accelerator;
determining a priority of the scan; and
assigning the kernel to the scan based at least in part on the priority of the scan.
Statement 52. An embodiment of the disclosure includes the article according to statement 51, wherein the accelerator is part of a database management system.
Statement 53. An embodiment of the disclosure includes the article according to statement 51, wherein the accelerator is separate from the storage device.
Statement 54. An embodiment of the disclosure includes the article according to statement 51, wherein the accelerator and the storage device are integrated into a single apparatus.
Statement 55. An embodiment of the disclosure includes the article according to statement 51, wherein identifying the scan of the table in the query includes receiving the query from a client.
Statement 56. An embodiment of the disclosure includes the article according to statement 55, wherein receiving the query from the client includes retrieving the query from a database management system.
Statement 57. An embodiment of the disclosure includes the article according to statement 56, wherein the database management system receives the query from the client.
Statement 58. An embodiment of the disclosure includes the article according to statement 51, wherein identifying the scan of the table in the query includes parsing the query to identify the scan of the table.
Statement 59. An embodiment of the disclosure includes the article according to statement 51, wherein identifying the scan of the table in the query includes identifying the scan of the table in the query using a database management system.
Statement 60. An embodiment of the disclosure includes the article according to statement 51, wherein determining the priority of the scan includes calculating the priority of the scan based at least in part on a first size of the table or a second size of an amount of data from the table in a cache.
Statement 61. An embodiment of the disclosure includes the article according to statement 60, wherein the cache includes a first cache of a database management system or a second cache or an operating system.
Statement 62. An embodiment of the disclosure includes the article according to statement 60, wherein determining the priority of the scan further includes determining the first size of the table or the second size of the amount of data from the table in the cache.
Statement 63. An embodiment of the disclosure includes the article according to statement 62, wherein determining the first size of the table and the second size of the amount of data from the table in the cache includes querying a database management system for the first size of the table or the second size of the amount of data from the table in the cache.
Statement 64. An embodiment of the disclosure includes the article according to statement 51, wherein:
identifying the kernel in the accelerator includes identifying the kernel and a second kernel in the accelerator;
assigning the kernel to the scan based at least in part on the priority of the scan includes assigning the kernel and the second kernel to the scan based at least in part on the priority of the scan.
Statement 65. An embodiment of the disclosure includes the article according to statement 51, wherein:
identifying the scan of the table in the query includes identifying the scan of the table and a second scan of a second table in the query;
determining the priority of the scan includes determining the priority of the scan and a second priority for the second scan; and
assigning the kernel to the scan or the second scan based at least in part on the priority of the scan and the second priority of the second scan.
Statement 66. An embodiment of the disclosure includes the article according to statement 51, the non-transitory storage medium having stored thereon further instructions that, when executed by the machine, result in executing the scan using the kernel.
Statement 67. An embodiment of the disclosure includes the article according to statement 66, wherein executing the scan using the kernel includes flushing a first cache of a database management system or a second cache of an operating system.
Statement 68. An embodiment of the disclosure includes the article according to statement 67, wherein flushing the first cache of the database management system or the second cache of the operating system includes writing dirty data from the first cache of the database management system or the second cache of the operating system to the storage device.
Statement 69. An embodiment of the disclosure includes the article according to statement 67, wherein flushing the first cache of the database management system or the second cache of the operating system includes deleting valid data from the first cache of the database management system or the second cache of the operating system.
Statement 70. An embodiment of the disclosure includes the article according to statement 67, wherein flushing the first cache of the database management system or the second cache of the operating system includes flushing the first cache of the database management system or the second cache of the operating system based at least in part on the database management system selecting the kernel to execute the scan.
Statement 71. An embodiment of the disclosure includes the article according to statement 66, wherein executing the scan using the kernel includes determining that the database management system selects the kernel to execute the scan.
Statement 72. An embodiment of the disclosure includes the article according to statement 71, wherein executing the scan using the kernel further includes allocating the kernel to the scan.
Statement 73. An embodiment of the disclosure includes the article according to statement 51, the non-transitory storage medium having stored thereon further instructions that, when executed by the machine, result in releasing the kernel based at least in part on a database management system selecting a software to execute the scan.
Statement 74. An embodiment of the disclosure includes the article according to statement 73, wherein:
assigning the kernel to the scan based at least in part on the priority of the scan includes storing a first timestamp; and
releasing the kernel based at least in part on the database management system selecting the software to execute the scan includes:
   determining a second timestamp; and
   determining that a difference between the first timestamp and the second timestamp exceeds a threshold difference.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. An apparatus, comprising:
a storage device, the storage device storing a database including a table; and
an accelerator connected to the storage device, the accelerator including a kernel;
a scan priority calculator to calculate a priority of a scan of the table in the database stored on the storage device, the scan associated with a query; and
a kernel assignment unit to assign the kernel to the scan based at least in part on the priority of the scan.

2. The apparatus according to claim 1, further comprising a receiver to receive the query from a client.

3. The apparatus according to claim 1, wherein the scan priority calculator is configured to calculate the priority of the scan based at least in part on a first size of the table or a second size of an amount of data from the table in a cache.

4. The apparatus according to claim 3, further comprising a cache query unit to determine the second size of the amount of the data from the table in the cache.

5. The apparatus according to claim 1, wherein the kernel assignment unit is configured to assign the kernel to the scan of the scan and a second scan based at least in part on the priority of the scan and a second priority of the second scan.

6. The apparatus according to claim 1, further comprising a cache flush unit to flush a first cache of a database management system or a second cache of an operating system to the storage device.

7. The apparatus according to claim 6, wherein the cache flush unit is configured to execute based at least in part on the database management system selecting the kernel to execute the scan.

8. The apparatus according to claim 1, further comprising a kernel release unit configured to release the kernel based at least in part on a database management system selecting a software to execute the scan.

9. The apparatus according to claim 8, wherein:
the kernel assignment unit is configured to associate a first timestamp with the kernel and the scan; and
the kernel release unit is configured to release the kernel based at least in part on a threshold difference between the first timestamp and a second timestamp.

10. A method, comprising:
identifying a kernel in an accelerator;
identifying a scan of a table in a query, the table stored in a database on a storage device connected to the accelerator;
determining a priority of the scan; and
assigning the kernel to the scan based at least in part on the priority of the scan.

11. The method according to claim 10, wherein determining the priority of the scan includes calculating the priority of the scan based at least in part on a first size of the table or a second size of an amount of data from the table in a cache.

12. The method according to claim 11, wherein determining the priority of the scan further includes determining the first size of the table or the second size of the amount of data from the table in the cache.

13. The method according to claim 10, wherein:
identifying the scan of the table in the query includes identifying the scan of the table and a second scan of a second table in the query;
determining the priority of the scan includes determining the priority of the scan and a second priority for the second scan; and
assigning the kernel to the scan or the second scan based at least in part on the priority of the scan and the second priority of the second scan.

14. The method according to claim 10, further comprising executing the scan using the kernel.

15. The method according to claim 14, wherein executing the scan using the kernel includes flushing a first cache of a database management system or a second cache of an operating system.

16. The method according to claim 10, further comprising releasing the kernel based at least in part on a database management system selecting a software to execute the scan.

17. The method according to claim 16, wherein:
assigning the kernel to the scan based at least in part on the priority of the scan includes storing a first timestamp; and
releasing the kernel based at least in part on the database management system selecting the software to execute the scan includes:
determining a second timestamp; and
determining that a difference between the first timestamp and the second timestamp exceeds a threshold difference.

18. An article, comprising a non-transitory storage medium, the non-transitory storage medium having stored thereon instructions that, when executed by a machine, result in:
identifying a kernel in an accelerator;
identifying a scan of a table in a query, the table stored in a database on a storage device connected to the accelerator;
determining a priority of the scan; and
assigning the kernel to the scan based at least in part on the priority of the scan.

19. The article according to claim 18, wherein determining the priority of the scan includes calculating the priority of the scan based at least in part on a first size of the table or a second size of an amount of data from the table in a cache.

20. The article according to claim 18, the non-transitory storage medium having stored thereon further instructions that, when executed by the machine, result in releasing the kernel based at least in part on a database management system selecting a software to execute the scan.
